(19) United States
(12) Patent Application Publication
(10) Pub. No.: US 2026/0278899 A1
(43) Pub. Date: Sep. 17, 2026

(54) AUDIO-DRIVEN CHARACTER ANIMATION USING DIFFUSION MODELS

(71) Applicant: NVIDIA Corporation, Santa Clara, CA (US)

(72) Inventors: Zhengyu Huang, Zhejiang (CN); Aleksei Karmanov, Yerevan (AM); Roger Blanco Ribera, Seongnam-si (KR); Dmitry Korobchenko, London (GB); Yeongho Seol, Seoul (KR)

(21) Appl. No.: 19/272,665

(22) Filed: Jul. 17, 2025

(30) Foreign Application Priority Data
Mar. 17, 2025 (WO) PCT/CN2025/082861

(51) Int. Cl. G06T 13/20; G06T 5/60; G06T 5/70; G06T 13/40; G10L 15/04

(52) U.S. Cl. CPC G06T 13/205; G06T 5/60; G06T 5/70; G06T 13/40; G10L 15/04

(57) ABSTRACT

In various examples, audio-driven character animation using diffusion models is described herein. Systems and methods described herein may use a diffusion model that is trained to perform improved audio-driven character animation for real-time and/or near real-time applications. For instance, the diffusion model may be trained to encode and/or decode components of the face—such as the tongue, the eyes, the gums, and/or the like—separately when animating the character to provide realistic character animation. Additionally, such as during inference, the diffusion model may be configured to process segments of the audio during different processing stages by at least generating and storing state information that relates the processing stages. Furthermore, such as to further reduce the latency, the diffusion model may process data using a specific number of diffusion steps—such as ten or less diffusion steps—when generating denoised frames representing the animated character.

### CROSS-REFERENCE TO RELATED APPLICATIONS

This application claims priority to PCT Application No. PCT/CN2025/082861, filed Mar. 17, 2025, which is hereby incorporated by reference in its entirety.

### BACKGROUND

Interactive characters—such as avatars—are used in a wide variety of applications to interact with users through speech. As such, various models have been developed—such as regression-based models—that render these characters based on audio inputs representing speech. For instance, audio may be input into a model that processes the audio to generate frames representing the character animated as if the character was speaking. However, when performing such processing using some models—such as models that perform regression-to-mean processing, similar audio inputs may map to multiple output variations that are then averaged to determine a final output animation, which may not reflect the audio input accurately and/or may include inconsistencies and other artifacts that can impact the quality and realism of the animation. For instance, averaging upper face motion may suppress the magnitude or frequency of motion, causing an animated subject to appear neutral or less interested, while averaging lower face motion—such as lip syncing—may cause inaccurate or imprecise lip motion (e.g., mouths that do not fully close or open). Additionally, some models require an entirety of the audio to be processed before generating frames representing animated characters, which makes inference slow and/or inadequate for real-time applications.

### SUMMARY

Embodiments of the present disclosure relate to audio-driven character animation using diffusion models. Systems and methods described herein may use a diffusion model that is trained to perform improved audio-driven character animation for real-time and/or near real-time applications. For instance, the diffusion model may be trained to encode and/or decode data associated with components of the face—such as the tongue, the eyes, the gums, and/or the like—separately when animating the character to provide realistic character animation. Additionally, such as during inference, the diffusion model may be configured to process segments of the audio during different processing stages by at least generating and storing state information that relates to the processing stages. Furthermore, such as to further reduce the latency and/or conserve computing resources, the diffusion model may process data using a specific number of diffusion steps—such as ten or less diffusion steps—when generating denoised frames representing the animated character.

One or more embodiments of the present disclosure use a diffusion model that models the distribution of all possible outputs for one or more (e.g., each) time step; this is in contrast to conventional systems that use other types of models—such as regression-based models—which may generate only a single output at each time step. This may improve the animation of characters by providing candidate outputs with more realistic facial expressions and/or mouth shapes, since given sounds may correspond to multiple facial animations. Additionally, in contrast to the conventional systems, the systems of the present disclosure, in some embodiments, use a diffusion model that is configured to process audio using a lesser number of diffusion steps—such as ten or less diffusion steps—and/or process segmented portions of the audio during different processing stages. By performing such processes, the diffusion model may process audio with reduced latency as compared to the models of the conventional systems, allowing the application of generative diffusion models for real-time and/or near real-time applications.

### BRIEF DESCRIPTION OF THE DRAWINGS

The present systems and methods for audio-driven character animation using diffusion models are described in detail below with reference to the attached drawing figures, wherein:

FIG. 1 illustrates an example data flow diagram for a process for using a diffusion model to animate a character, in accordance with some embodiments of the present disclosure;

FIGS. 2A-2B illustrate an example of a diffusion model that may be used to perform audio-driven animation of characters, in accordance with some embodiments of the present disclosure;

FIG. 3 illustrates an example of segmenting audio into segments for processing, in accordance with some embodiments of the present disclosure;

FIGS. 4A-4D illustrate an example of processing audio in segments over multiple diffusion steps, in accordance with some embodiments of the present disclosure;

FIG. 5 illustrates an example of using a diffusion model to animate a character during inference, in accordance with some embodiments of the present disclosure;

FIG. 6 illustrates an example data flow diagram for a process of training a diffusion model to perform audio-drive character animation, in accordance with some embodiments of the present disclosure;

FIG. 7 illustrates a flow diagram showing a method for using a diffusion model that denoises multiple components together when animating a character, in accordance with some embodiments of the present disclosure;

FIG. 8 illustrates a flow diagram showing a method for using a diffusion model to process audio in segments when animating a character, in accordance with some embodiments of the present disclosure;

FIG. 9 illustrates a flow diagram showing a method for using a diffusion model to animate a character using different emotional states, in accordance with some embodiments of the present disclosure;

FIG. 10 is a block diagram of an example computing device suitable for use in implementing some embodiments of the present disclosure; and

FIG. 11 is a block diagram of an example data center suitable for use in implementing some embodiments of the present disclosure.

### DETAILED DESCRIPTION

Systems and methods are disclosed for generative audio-driven character animation using diffusion models. For instance, a system(s) may use a diffusion model that includes an improved architecture for processing inputs to generate outputs representing animated characters. For example, input data for the diffusion model may include audio associated with speech, noisy frames associated with a character, one or more timestamps indicating a number of diffusion steps to use when processing the input data, an identifier associated with a subject for which the character represents, one or more emotional states associated with animating the character, and/or any other information associated with animating the character. The diffusion model may then process the input data to generate output data that includes denoised frames associated with the input noisy frames, where the denoised frames represent the animation of the character. For instance, the denoised frames may include an animation (e.g., sequence of image frames) depicting the character speaking (e.g., pronouncing, vocalizing, emitting, etc.) that is synchronized with the speech associated with the audio.

For more details, and with regard to a single instance of the input data, the diffusion model may use one or more encoders to process the input data and generate features (e.g., embeddings) associated with the inputs. For instance, the encoder(s) may generate an audio projection (e.g., an audio feature) associated with the audio, an input projection (e.g., a frame feature) associated with a noisy frame, a time embedding (e.g., a time feature) associated with the timestep, an identity embedding (e.g., an identity feature) associated with the identity, and/or an emotional state embedding (e.g., an emotion feature) associated with the emotional state. The encoder(s) may then generate a first output by combining—such as by concatenating, adding, fusing, and/or the like—the features together.

The diffusion model may then process the first output using one or more layers to generate a second output. As described herein, the layer(s) may include, but is not limited to, one or more gated recurrent unit (GRU) layers, one or more recurrent neural network (RNN) layers, one or more transformer layers, and/or any other type of layers that are configured to perform at least a portion of the processing described herein. For instance, if the layer(s) includes the GRU layer(s), then the GRU layer(s) may process the first output along with state information associated with one or more previous inputs to generate the second output.

The diffusion model may then use one or more decoders to process the second output. As described in more detail herein, the decoder(s) may include multiple heads that are associated with various components of the face of the character. For instance, the decoder(s) may use a face head, a tongue head, a gum head, and/or an eye head that individually process the second output to generate third outputs associated with the components of the face of the character. The decoder(s) may then generate a fourth output by combining—such as by concatenating, adding, fusing, and/or the like—the third outputs. As described herein, in some examples, the fourth output may represent motion associated with an animation of a character. As such, the decoder(s) may further process the fourth output with respect to a template of the character to generate a denoised frame associated with the input. Additionally, the diffusion model may perform similar processes for one or more additional instances of the input data to generate additional denoised frames that depict an animation of the character.

In some examples, by performing these processes when processing the input data—such as encoding and/or decoding the face, tongue, eyes, gums, and/or other components of the face of the character independently—the diffusion model may include an increased capacity to better model the motion of the character. Additionally, and as described in more detail herein, the diffusion model may predict the denoised animation instead of estimating noise as in other diffusion models. In other words, the architecture of the diffusion model may allow for the diffusion model to animate characters using more realistic motion.

As described herein, the system(s) may configure the processing performed by the diffusion model to reduce the latency such that the diffusion model may be used for real-time and/or near real-time applications. For instance, in some examples, the system(s) may configure the diffusion model such that the processing is performed using a reduced number of diffusion steps—such as ten or less diffusion steps—to reduce the latency. For example, and with regard to an instance of input data that represents one or more noisy frames, the diffusion model may perform one or more of the processes described herein to generate one or more first denoised frames representing an animated character during a first diffusion step. The diffusion model may then again perform the process(es) described herein to process input data representing at least the one or more first denoised frames to generate one or more second denoised frames representing the animated character during a second diffusion step. This process may then continue for the number of diffusion steps until the diffusion model generates one or more final denoised frames representing the animated character.

Additionally, in some examples, the system(s) may set a window size associated with segmenting the audio during processing. For instance, the window size may indicate a length of the audio to process during a single processing stage, such as 15 seconds, 30 seconds, 1 minute, and/or the like, and/or a number of noisy frames to process during the single processing stage, such as two frames, ten frames, fifty frames, and/or any other number of frames. This way, the diffusion model may not be required to process an entirety of the audio during a single processing stage, which may allow for the diffusion model to also generate and/or output the denoised frames representing the animated character in multiple processing stages for real-time and/or near real-time applications.

For example, during a first processing stage, the diffusion model may process first input data representing at least one or more first noisy frames along with a first portion of the audio that is associated with the first noisy frame(s). Based at least on the processing, the diffusion model may output one or more first denoised frames representing the character animated according to the first portion of the audio, and store state data associated with processing the first input data. For instance, in some examples, the state data may represent one or more latent variables associated with the processing performed by the layer(s) between the encoder(s) and the decoder(s). The diffusion model may then process the state data along with second input data representing at least one or more second noisy frames along with a second portion of the audio that is associated with the second noisy frame(s). Based at least on the processing, the diffusion model may both output one or more second denoised frames representing the character animated according to the second portion of the audio, and store additional state data associated with the processing of the second input data. This process may then continue to repeat as the diffusion model continues processing segments of the audio.

In some examples, the system(s) may further configure the diffusion model to generate more realistic animations that better represent the emotional states of the character. For instance, and as described herein, the input data may represent different emotional states associated with different noisy frames. As described herein, an emotional state such as, for example and without limitation: neutral, happy, angry, scared, sad, joy, shame, envy, and/or any other emotional state. As such, the diffusion model may generate the individual denoised frames corresponding to the different noisy frames based on the emotional states. This way, the diffusion model may generate the animation of the character such that the emotional states of the character change over a period of time.

As described herein, the system(s) (and/or another system(s)) may perform one or more processes to train the diffusion model to perform one or more of the processes described herein. For instance, the system(s) may use training input data representing noisy frames associated with an animated character along with one or more conditions, such as audio, an identifier of the character, one or more timesteps, and/or one or more emotional states. In some examples, the system(s) generates the noisy frames by adding noise to ground truth data. The system(s) may then cause the diffusion model to process the training input data and generate output data representing predicted denoised frames associated with animating the character. Additionally, the system(s) may determine one or more losses between the predicted denoised frames and noiseless frames from the ground truth data and use the loss(es) to update one or more parameters and/or weights associated with the diffusion model. While this is just one example technique for how the system(s) may train the diffusion model, in other examples, the system(s) may use additional and/or alternative techniques to train the diffusion model.

In some examples, the model(s) (e.g., diffusion model, machine learning models, deep neural networks, language models, LLMs, VLMs, multi-modal language models, perception models, tracking models, fusion models, transformer models, diffusion models, encoder-only models, decoder-only models, encoder-decoder models, neural rendering field (NERF) models, neural networks, etc.) described herein may be packaged as a microservice—such an inference microservice (e.g., NVIDIA NIMs)—which may include a container (e.g., an operating system (OS)-level virtualization package) that may include an application programming interface (API) layer, a server layer, a runtime layer, and/or a model “engine.” For example, the inference microservice may include the container itself and the model(s) (e.g., weights and biases). In some instances, such as where the machine learning model(s) is small enough (e.g., has a small enough number of parameters), the model(s) may be included within the container itself. In other examples—such as where the model(s) is large—the model(s) may be hosted/stored in the cloud (e.g., in a data center) and/or may be hosted on-premises and/or at the edge (e.g., on a local server or computing device, but outside of the container). In such embodiments, the model(s) may be accessible via one or more APIs—such as REST APIs. As such, and in some embodiments, the machine learning model(s) described herein may be deployed as an inference microservice to accelerate deployment of a model(s) on any cloud, data center, or edge computing system, while ensuring the data is secure.

For example, the inference microservice may include one or more APIs, a pre-configured container for simplified deployment, an optimized inference engine (e.g., built using a standardized AI model deployment an execution software, such as NVIDIA's Triton Inference Server, and/or one or more APIs for high performance deep learning inference, which may include an inference runtime and model optimizations that deliver low latency and high throughput for production applications—such as NVIDIA's TensorRT), and/or enterprise management data for telemetry (e.g., including identity, metrics, health checks, and/or monitoring). The machine learning model(s) described herein may be included as part of the microservice along with an accelerated infrastructure with the ability to deploy with a single command and/or orchestrate and auto-scale with a container orchestration system on accelerated infrastructure (e.g., on a single device up to data center scale). As such, the inference microservice may include the machine learning model(s) (e.g., that has been optimized for high performance inference), an inference runtime software to execute the machine learning model(s) and provide outputs/responses to inputs (e.g., user queries, prompts, etc.), and enterprise management software to provide health checks, identity, and/or other monitoring. In some embodiments, the inference microservice may include software to perform in-place replacement and/or updating to the machine learning model(s). When replacing or updating, the software that performs the replacement/updating may maintain user configurations of the inference runtime software and enterprise management software.

The systems and methods described herein may be used by, without limitation, non-autonomous vehicles or machines, semi-autonomous vehicles or machines (e.g., in one or more adaptive driver assistance systems (ADAS)), autonomous vehicles or machines, piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems implementing large language models (LLMs), systems implementing one or more vision language models (VLMs), systems implementing one or more multi-modal language models, systems using or deploying one or more inference microservices, systems that incorporate deploy one or more machine learning models in a service or microservice along with an OS-level virtualization package (e.g., a container), systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems for performing generative AI operations, systems implemented at least partially using cloud computing resources, and/or other types of systems.

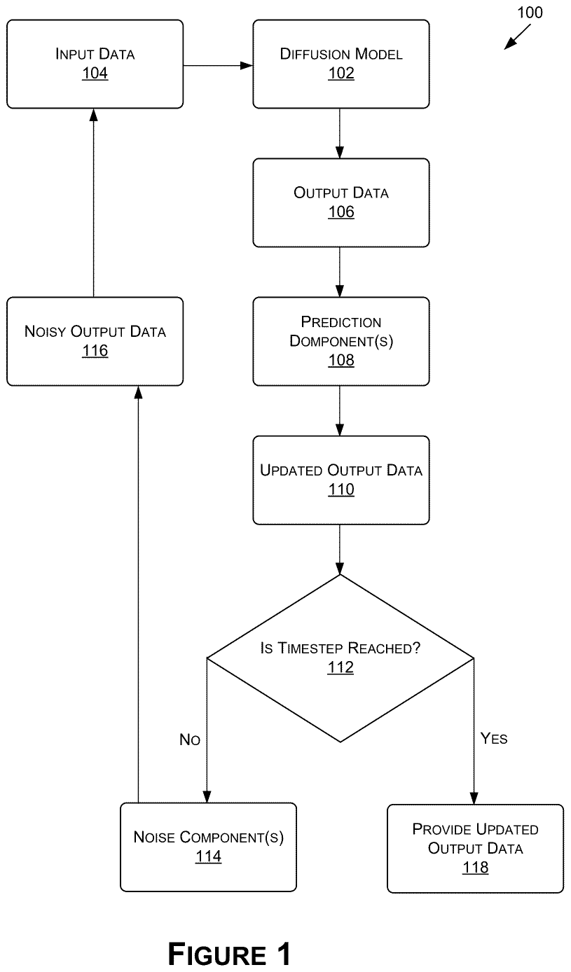

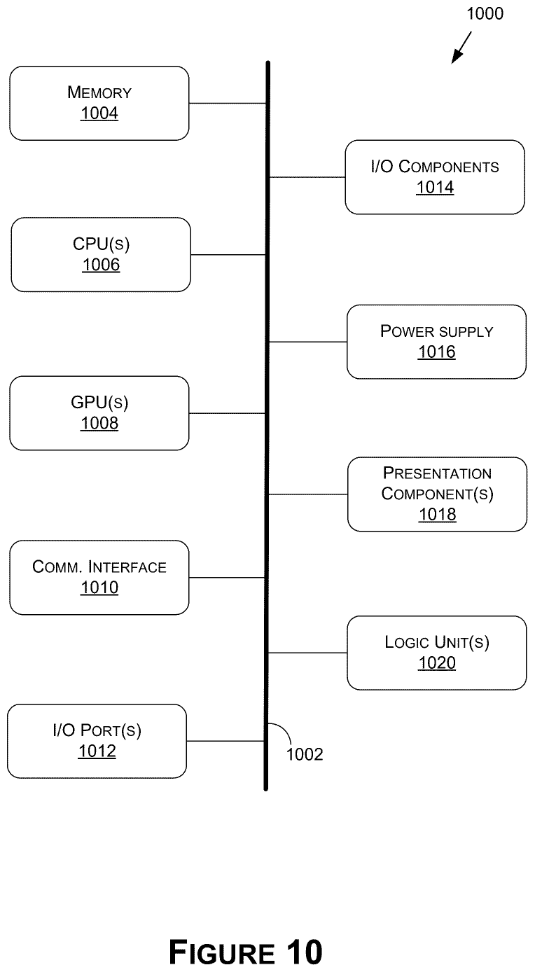

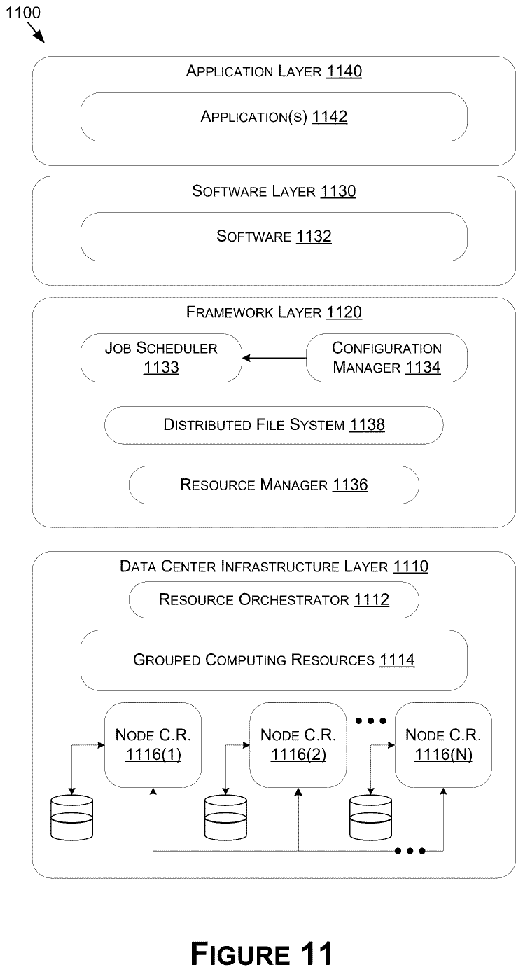

With reference to FIG. 1, FIG. 1 illustrates an example data flow diagram for a process 100 for using a diffusion model 102 to animate a character, in accordance with some embodiments of the present disclosure. If should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. In some embodiments, the systems, methods, and processes described herein may be executed using similar components, features, and/or functionality to those of example computing device 1000 of FIG. 10 and/or example data center 1100 of FIG. 11.

The process 100 may include applying input data 104 to the diffusion model 102. As descried herein, the input data 104 may include, but is not limited to, noisy frames associated with a character, audio associated with speech, a timestep indicating a number of diffusion steps to perform with regard to the input data 104 (which is described in more detail herein), an identifier associated with a character to animate, one or more emotional states associated with the character, and/or any other information for animating the character. Additionally, in some examples, a noisy frame associated with an initial diffusion step for the diffusion model 102 may be determined using a distribution—such a Gaussian distribution (and/or any other type of distribution)—while additional diffusion steps performed by the diffusion model 102 use denoised frames produced by the diffusion model 102, which is described in more detail herein. The process 100 may then include the diffusion model 102 processing the input data 104 to generate output data 106 representing denoised frames associated with the noisy frames, where the denoised frames represent an animation of the character.

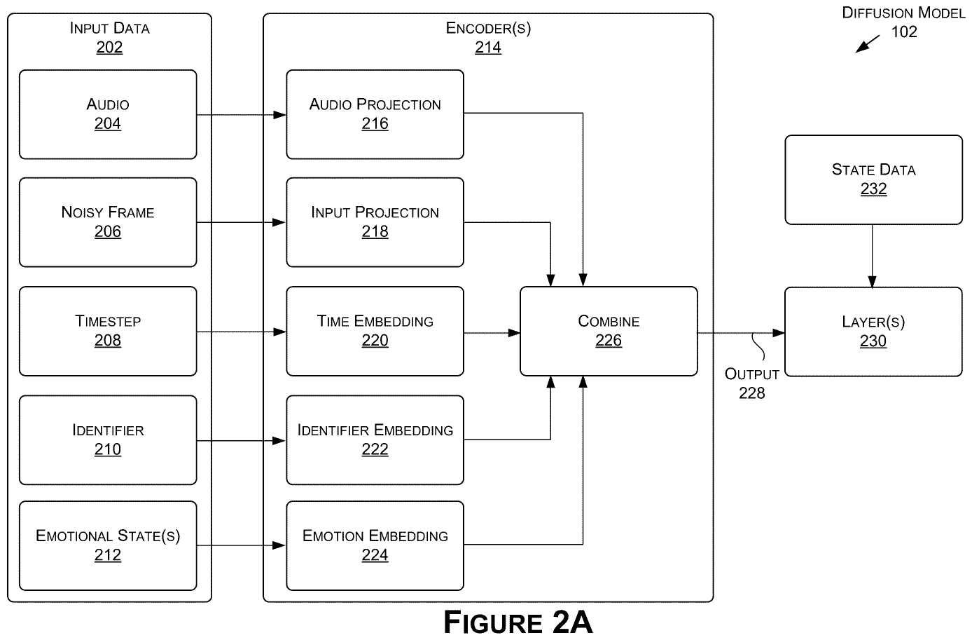

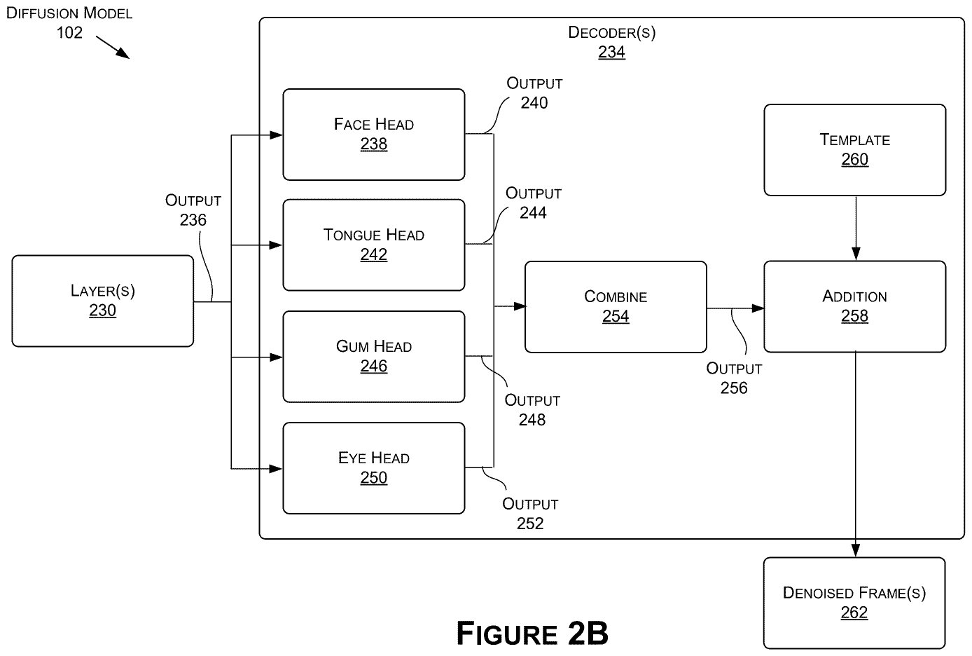

For more details, FIGS. 2A-2B illustrate an example of the diffusion model 102 that may be used to perform audio-driven animation of characters, in accordance with some embodiments of the present disclosure. As shown by the example of FIG. 2A, input data 202 (which may include, and/or be similar to, the input data 104) may be input into the diffusion model 102. As shown, the input data 202 may represent at least audio 204, noisy frames 206, a timestep 208, an identifier 210 of a character, and/or one or more emotional states 212. In some examples, the noisy frames 206 may represent at least one or more dimensions associated with one or more components of the character, such as the tongue, the eyes, the gums, and/or the face of the character. For an example, the face may include 72,006 dimensions, the tongue may include 16,806 dimensions, the gums may include 15 dimensions, and the eye may include 4 dimensions. However, while these are just a few example dimensions for the component(s) of the character, in other examples, the component(s) of the character may include any other dimensions.

Additionally, in some examples, the audio 204 may include a specific frequency, such as 16,000 hertz (and/or any other frequency). Furthermore, in some examples, one or more of the other inputs may be represented using one or more vectors. For a first example, different identities for characters may be associated with different vectors, where the identifier 210 from the input data 202 then includes a vector associated with the selected character to animate. In such an example, the vectors associated with the identities may include dimensions that are based at least on the number of identities for which the diffusion model 102 is trained to process. For a second example, different emotional states may be associated with different vectors, where the emotional state 212 from the input data 202 then includes a vector. In such an example, the vectors associated with the emotional states may include dimensions that are based at least on the number of emotional states for which the diffusion model 102 is trained to process.

The diffusion model 102 may then use one or more encoders 214 to process the input data 202 and generate features associated with the various inputs. For instance, the encoder(s) 214 may process the audio 204 to generate a representation associated with the audio 204—such as a bidirectional encoder representation from transformers (BERT), a hidden-unit-BERT (HuBERT), and/or any other type of representation. The encoder(s) 214 may then interpolate the representation to generate an audio projection 216 (e.g., audio features) associated with the audio 204. For instance, the representation may be interpolated to include a frequency that is associated with the frame rate of the presentation of the animated character, such as the frame rate of the noisy frames 206. Additionally, the encoder(s) 214 may process the noisy frame(s) 206 to generate an input projection 218 (e.g., input features), process the timestep 208 to generate a time embedding 220 (e.g., a time feature), process the identifier 210 to generate an identity embedding 222 (e.g., an identity feature), and/or process an emotional state 212 to generate an emotional embedding 224 (e.g., an emotional feature).

In some examples, the features may be associated with given dimensions. For example, the audio projection 216 may include parameters (B, T, 256), the input projection 218 may include parameters (B, T, 285), the time embedding 220 may include parameters (B, T, 256), the identity embedding 222 may include (B, T, 32), and the emotional embedding 224 may include parameters (B, T, 32). In such an example, B represents a batch size indicating a number of audio tracks that are processed in parallel during a processing stage while T represents a number of animation frames being processed during a time window, which is described in more detail herein. However, in other examples, the features may be associated with any other dimensions.

The encoder(s) 214 may then combine 226 the features—such as by concatenating the features, adding the features, fusing the features, and/or the like—to generate an output 228. In some examples, the output 228 may be associated with given dimensions. For instance, the output 228 may include dimensions that are based at least on the dimensions of the audio projection 216, the input projection 218, the time embedding 220, the identity embedding 222, and the emotional embedding 222. For example, and using the example above, the output 228 may include parameters (B, T, 861), such as by adding the dimensions from the features.

The diffusion model 102 may then include one or more layers 230 (e.g., two layers, five layers, ten layers, etc.) that process the output 228 from the encoder(s) 214 and/or state data 232. As described herein, the layer(s) may include, but is not limited to, one or more GRU layers, one or more RNN layers, one or more transformer layers, and/or any other type of layers that are configured to perform at least a portion of the processing described herein. Additionally, the state data 232 may represent one or more hidden states associated with previously processed input data. For example, such as when the layer(s) 230 includes the GRU layer(s), the state data 232 may represent one or more latent variables associated with performing one or more of the diffusion steps described herein. As such, in some examples, the diffusion model 102 may update the state data 232 as the diffusion model 102 continues to process additional input data 202.

Next, and as shown by the example of FIG. 2B, the diffusion model 102 may include one or more decoders 234 that are configured to process an output 236 from the layer(s) 230. In some examples, the output 236 may be associated with given dimensions. For example, and again using the example above, the output 236 may include (B, T, 256). However, in other examples, the output 236 may include any other dimensions.

To process the output 236, the decoder(s) 234 may include at least a face head 238 that is configured to process the output 236 to generate an output 240 associated with facial features of the character, a tongue head 242 that is configured to process the output 236 to generate an output 244 associated with the tongue features of the character, a gum head 246 that is configured to process the output 236 to generate an output 248 associated with the gum features of the character, and an eye head 250 that is configured to process the output 236 to generate an output 252 associated with the eye features of the character. In some examples, the outputs 240, 244, 248, and/or 252 may represent updated features associated with the character. For example, the output 240 may represent updated locations for the face features, the output 244 may represented updated locations for the tongue features, the output 248 may represent updated locations for the gum features, and/or the output 252 may represent updated locations for the eye features. Additionally, in some examples, the outputs 240, 244, 248, and 252 may include dimensions that are associated with the dimensions of the components of the character. For example, and again using the example above, the output 240 may include a set of parameters (B, T, 72006), the output 244 may include a set of parameters (B, T, 16806), the output 248 may include a set of parameters (B, T, 15), and the output 152 may include a set of parameters (B, T, 4).

The decoder(s) 234 may then combine 254 the features—such as by concatenating the features, adding the features, fusing the features, and/or the like—to generate an output 256. For instance, in some examples, the output 256 may represent motion associated with the character. Additionally, the output 256 may be associated with the given dimensions. For example, and again using the example above, the output 256 may include parameters (B, T, 88831). For instance, the dimensions may be based at least on adding the face dimensions, the tongue dimensions, the gum dimensions, and the eye dimensions.

The decoder(s) 234 may perform an addition process 258 that adds the output 256 to a template 260 associated with the character. For instance, the template 260 may be identified based at least on the identifier 210 from the input data 202, where the template 260 represents a neutral face associated with the character (e.g., a resting face without any motion applied). Additionally, the template may be associated with similar dimensions as the output 256, such as also including parameters (B, T, 88831). Furthermore, adding the output 256 to the template may add motion to the neutral face in order to create the animation of the character. For instance, the output from the diffusion model 102 may include one or more denoised frames 262 representing the character performing an animation.

In some examples, the diffusion model 102 may continue to perform these processes of processing input data 202 in order to generate denoised frames 262 representing the animated character. Additionally, in some examples, and as described in more detail herein, one or more of the inputs may change during the processing. For instance, the emotional states 212 associated with noisy frames 206 may change, such as when the character is to be animated using different emotions. For example, the character may originally include a first emotional state 212, such as happy (and/or any other emotional state), but then change to a second emotional state 212 after a period of time while speaking, such as sad (and/or any other emotional state). In such an example, the input data 202 may represent the different emotional states 212 for the respective noisy frames 206 such that the denoised frames 262 represent the character animated to express the different emotions.

Referring back to the example FIG. 1, the process 100 may include one or more prediction components 108 processing the output data 106 to generate updated output data 110 associated with animating the character. In some examples, the prediction component(s) 108 may generate the updated output data 110 by calculating the posterior mean associated with the animated character. For example, the updated output data 110 may represent one or more next denoised versions of the frame(s) representing the animated character if the diffusion model 102 were to again process the frame(s) using another diffusion step. In some examples, the prediction component(s) 108 may generate the updated output data 110 using one or more equations, such as the following:

$${\tilde{u}}_{t} ( {x}_{t} , {x}_{0} ) := \frac{\sqrt{{\overline{α}}_{t - 1}} {β}_{t}}{1 - {\overline{α}}_{t}} {x}_{0} + \frac{\sqrt{1 - {β}_{t}} ( 1 - {\overline{α}}_{t - 1} )}{1 - {\overline{α}}_{t}} {x}_{t} \qquad ( 1 )$$

$${\tilde{β}}_{t} := \frac{1 - {\overline{α}}_{t - 1}}{1 - {\overline{α}}_{t}} {β}_{t} \qquad ( 2 )$$

where xₜ represents an input frame, x₀ represents an output frame, uₜ represents the predicted frame, and βₜ represents hyperparameter controls for how much noise to add for individual diffusion steps. In some examples, the hyperparameter control may increase linearly. As such, by using equations (1) and (2), the prediction component(s) 108 may weigh the noisy version of the character with respect to the denoised version of the character to determine the predicted version of the character.

The process 100 may then include determining whether a set timestep is reached 112. As described herein, the set timestep may be associated with a number of diffusion steps to perform when processing input data 104. Additionally, in some examples, such as to reduce the latency associated with animating the character while also maintaining a high-quality animation, the number of timesteps may be less than or equal to a threshold number of diffusion iterations, such as ten timesteps. For instance, in some examples, the timestep may include two.

For instance, and as shown, if it is determined that the timestep is not reached (e.g., the timestep is greater than 0) at 112, then the process may include using one or more noise components 114 to add noise to the predicted animation represented by the updated output data 110 to generate noisy output data 116. For instance, the noisy output data 116 may represent one or more noisy frames representing the animated character. In some examples, the noise component(s) 114 may use one or more techniques to add the noise, such as by sampling using the following:

$${x}_{\{ t - 1 \}} = {u}_{t} + {σ}_{t} \cdot z \qquad ( 3 )$$

where x₍ₜ₋₁₎ represents the noisy animation, t represents the timestep, and z represents the noise. In some examples, the noise component(s) 114 may further update the timestep—such as by reducing the timestep by 1 (and/or any other value)—for the next diffusion step.

The process 100 may then include performing the processes described herein to perform the next diffusion step, but with replacing the noisy frame(s) from the input data 104 with the noisy frame(s) from the noisy output data 116 and with using the reduced timestep. In some examples, the processes may then continue to be performed for any number of diffusion steps until it is determined that the set timestep is reached. For instance, in some examples, the processes may continue to perform until the timestep is no longer greater than zero. At that point, the process 100 may include providing the updated output data 118 as the final output for animating the character.

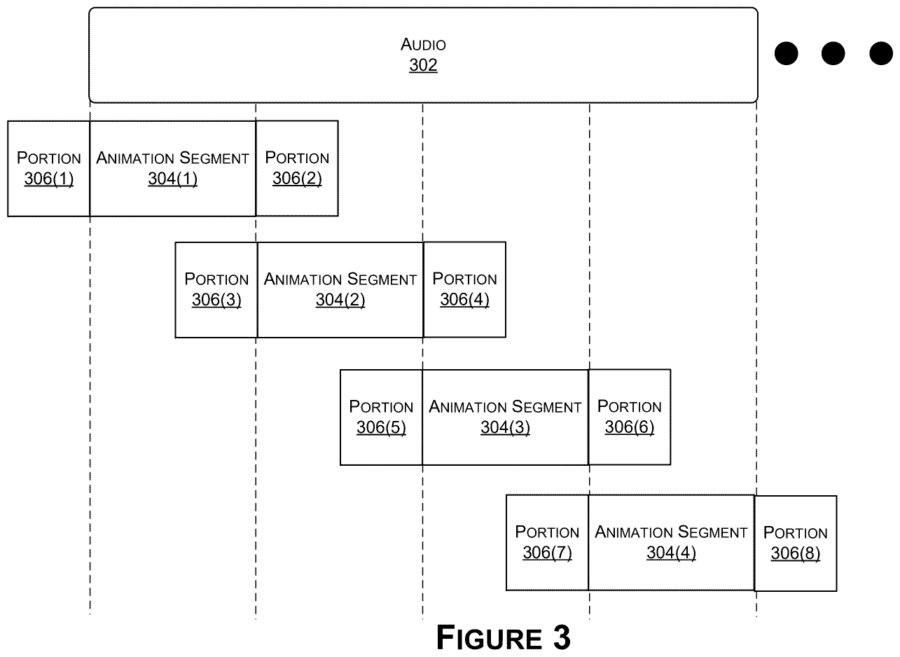

As described herein, in some examples, one or more techniques may be used to improve the overall process 100, such as by reducing the latency associated with animating the character for an entirety of the audio. For instance, FIG. 3 illustrates an example of segmenting audio 302 into segments for processing, in accordance with some embodiments of the present disclosure. As shown, the audio 302, which may be included as part of the input data 104 in the example of FIG. 1, may be segmented into segments 304(1)-(4) (also referred to singularly as “segment 304” or in plural as “segments 304”). In some examples, the segments 304 may be associated with a specific time interval of the audio 302, such as 30 seconds (and/or any other time interval). Additionally, or alternatively, in some examples, the segments 304 may be associated with a given number of frames for animating the character, such as 30 frames (and/or any other number of frames).

As further illustrated by the example of FIG. 3, in some examples, the segments 304 of the audio 302 may further be associated with additional audio portions 306(1)-(8) (also referred to singularly as “audio portion 306” or in plural as “audio portions 306”). For instance, the first segment 304(1) may be associated with a first audio portion 306(1) before the segment 304(1) and/or a second audio portion 306(2) after the segment 304(1). In some examples, the audio portions 306 may be associated with a specific time interval, such as 15 seconds (and/or any other time interval).

In some examples, the segments 304 may be associated with the additional audio portions 306 to improve the feature extractions performed by the diffusion model 102 and/or improve the animation of the character. For example, the diffusion model 102 may be able to generate better animations—such as by using one or more of the processes described herein—for at least non-verbal sounds—such as laughter—since the additional audio portions 306 allow for the diffusion model 102 to “hear” an entirety of the non-verbal sound which may make the animations more natural. Additionally, in some examples, the additional audio portions 306 may help smooth the animation between the segments 304 since the diffusion model 102 is not just processing completely new audio with regard to each of the segments 304 which would occur without the additional audio portions 306.

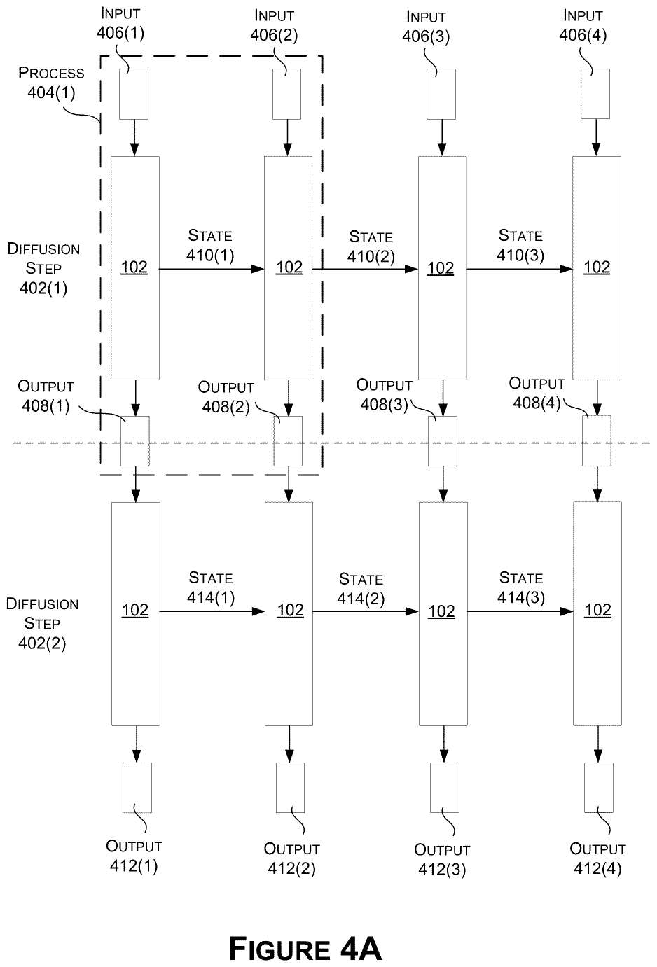

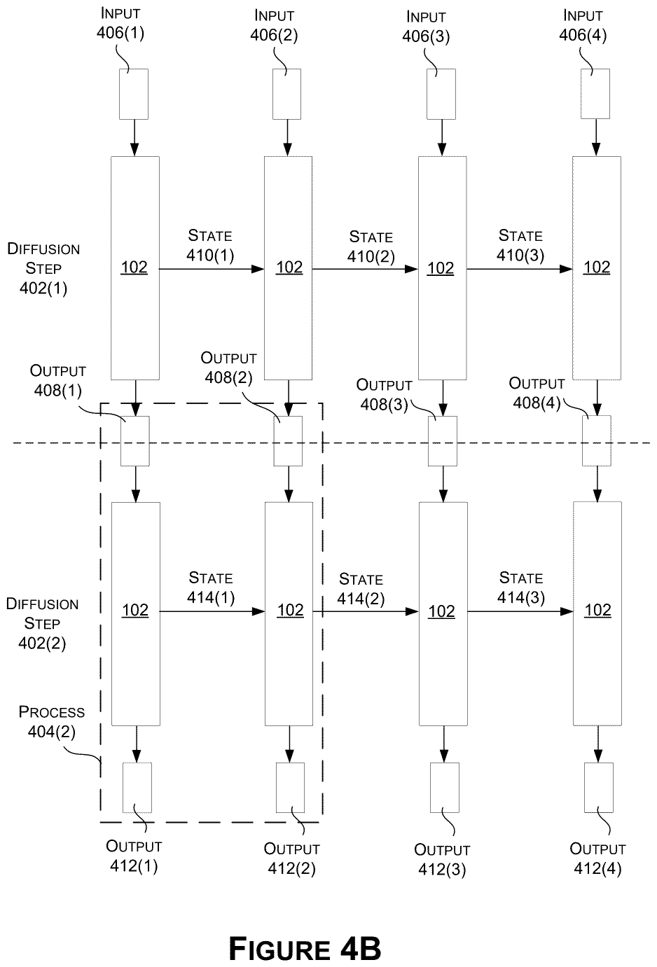

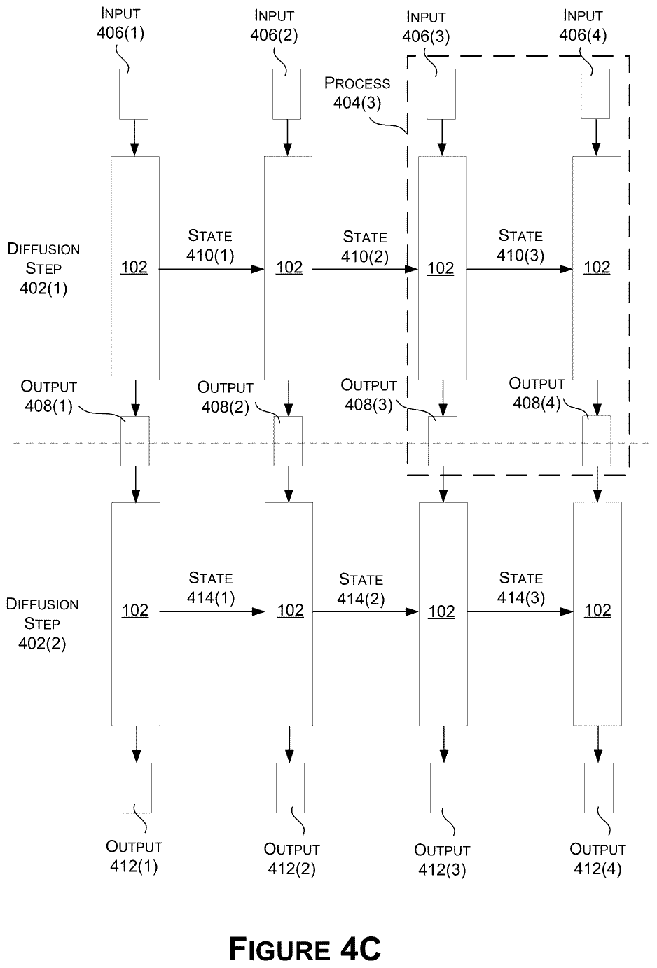

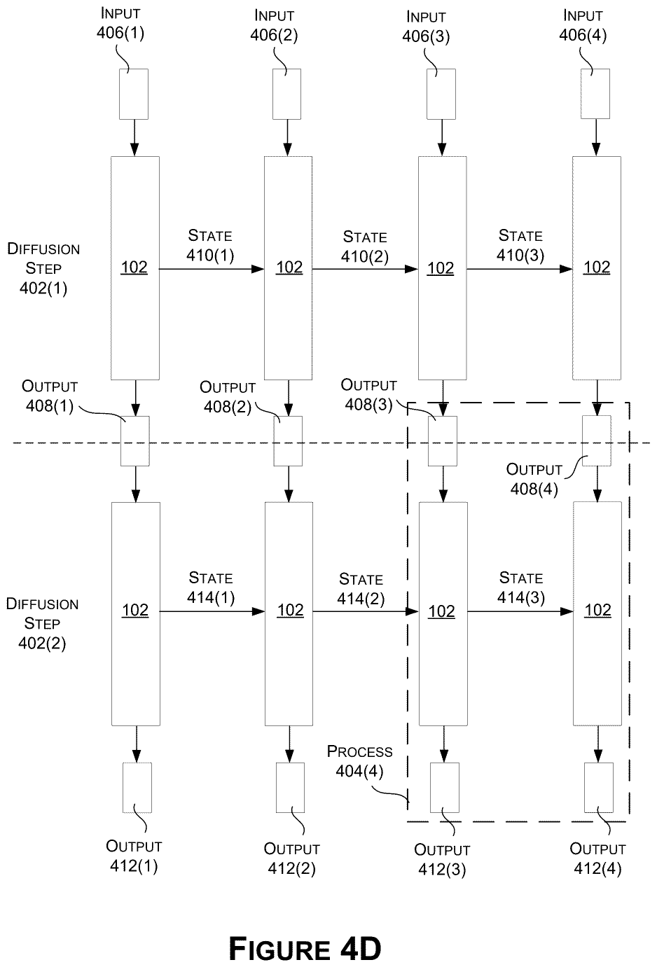

Next, FIGS. 4A-4D illustrate an example of processing the audio 302 in segments over multiple diffusion steps 402(1)-(2), in accordance with some embodiments of the present disclosure. As shown by the example of FIG. 4A, during a first processing operation 404(1), the first segment 304(1) associated with the audio 302 may be processed using the first diffusion step 402(1), where the first segment 304(1) includes at least a first frame and a second frame. For instance, a first input 406(1) associated with the first frame may be processed using the diffusion model 102 (e.g., at least the layer(s) 230) to generate a first output 408(1). Additionally, first state data 410(1) may be generated and/or stored, where the first state data 410(1) represents one or more hidden states (e.g., one or more hidden variables) associated with processing the first input 406(1). Next, a second input 406(2) associated with the second frame may be processed using the diffusion model 102 (e.g., at least the layer(s) 230), along with the first state data 410(1), to generate a second output 408(2). Additionally, second state data 410(2) may be generated and/or stored, where the second state data 410(2) represents one or more hidden states (e.g., one or more hidden variables) associated with processing the second input 406(2).

As shown by the example of FIG. 4B, during a second processing operation 404(2), the first segment 304(1) associated with the audio 302 may be processed using the second diffusion step 402(2). For instance, the first output 408(1) associated with the first frame may be processed using the diffusion model 102 (e.g., at least the layer(s) 230) to generate a first final output 412(1). Additionally, first state data 414(1) may be generated and/or stored, where the first state data 414(1) represents one or more hidden states (e.g., one or more hidden variables) associated with processing the first output 408(1). Next, the second output 408(2) associated with the second frame may be processed using the diffusion model 102 (e.g., at least the layer(s) 230), along with the first state data 414(1), to generate a second final output 412(2). Additionally, second state data 414(2) may be generated and/or stored, where the second state data 414(2) represents one or more hidden states (e.g., one or more hidden variables) associated with processing the second output 408(2).

As shown by the example of FIG. 4C, during a third processing operation 404(3), the second segment 304(2) associated with the audio 302 may be processed using the first diffusion step 402(1), where the second segment 304(2) includes at least a third frame and a fourth frame. For instance, a third input 406(3) associated with the third frame may be processed using the diffusion model 102 (e.g., at least the layer(s) 230), along with the second state data 410(2), to generate a third output 408(3). Additionally, third state data 410(3) may be generated and/or stored, where the third state data 410(3) represents one or more hidden states (e.g., one or more hidden variables) associated with processing the third input 406(3). Next, a fourth input 406(4) associated with the fourth frame may be processed using the diffusion model 102 (e.g., at least the layer(s) 230), along with the third state data 410(3), to generate a fourth output 408(4).

As shown by the example of FIG. 4D, during a fourth processing operation 404(4), the second segment 304(2) associated with the audio 302 may be processed using the second diffusion step 402(2). For instance, the third output 408(3) associated with the third frame may be processed using the diffusion model 102 (e.g., at least the layer(s) 230), along with the second state data 414(2), to generate a third final output 412(3). Additionally, third state data 414(3) may be generated and/or stored, where the third state data 414(3) represents one or more hidden states (e.g., one or more hidden variables) associated with processing the third output 408(3). Next, the fourth output 408(4) associated with the fourth frame may be processed using the diffusion model 102 (e.g., at least the layer(s) 230), along with the third state data 414(3), to generate a fourth final output 412(4).

In some examples, the inputs 406(1)-(4) may be associated with the noisy frames, such as by including the combined inputs (e.g., the concatenated inputs) that are input into the layer(s) 230. Additionally, the outputs 408(1)-(4) may be associated with initial denoised frames corresponding to the noisy frames while the final outputs 412(1)-(4) correspond to final denoised frames associated with the noisy frames. While the example of FIGS. 4A-4D illustrate performing two diffusion steps 402(1)-(2), in other examples, similar processes may be used to perform any number of diffusion steps.

Additionally, by performing the processing illustrated in the example of FIGS. 4A-4D, the diffusion model 102 is used to generate the denoised frames associated with the first segment 304(1) followed by the denoised frames associated with the second segment 304(2). In some examples, this process may then continue to generate the denoised frames associated with the third segment 304(3), followed by the denoised frames associated with the fourth segment 304(4), and/or so forth. As such, rather than processing an entirety of the audio 302 together during a single processing stage, which may require a large amount of computing resources and/or time to perform, the segmented processing of FIGS. 4A-4D may reduce the amount of computing resources needed and/or time it takes to process the audio 302. For instance, in some examples, the processing illustrated in FIGS. 4A-4D may allow for performing real-time and/or near real-time processing of the audio 302.

Additionally, in the example of FIGS. 4A-4D, multiple denoised frames representing the animated character may be generated using the diffusion model 102 during individual processing of the various segments 304. While the example of FIGS. 4A-4D illustrate processing two frames with regard to each of the segments 304, in other examples, any number of frames may be processed with regard to the segments 304.

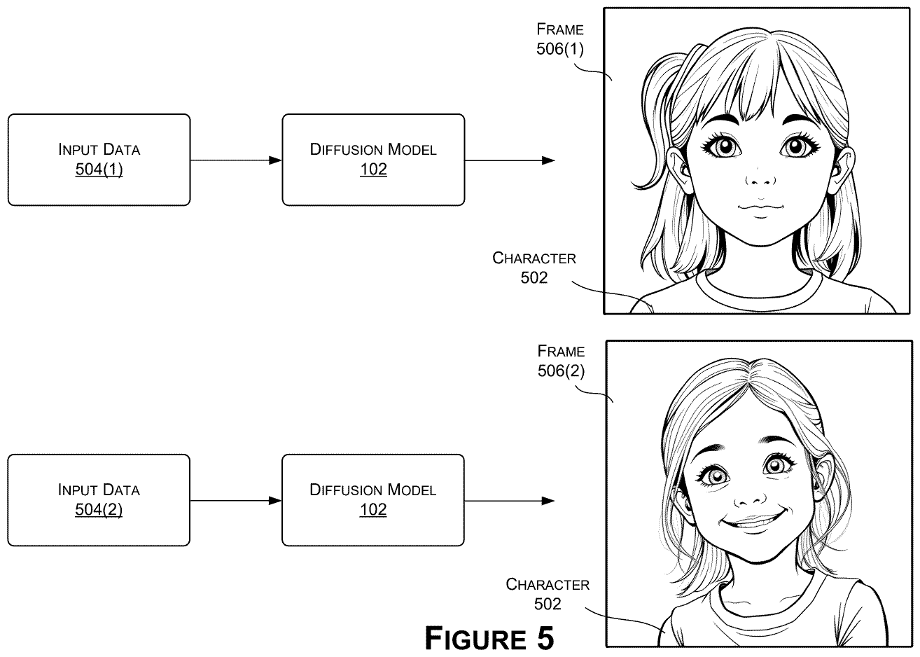

As described herein, by performing the processes described with respect to FIGS. 4A-4D, the diffusion model 102 may be able to perform audio-driven character animation in real-time and/or near real-time. FIG. 5 illustrates an example of using the diffusion model 102 to animate a character 502 during inference, in accordance with some embodiments of the present disclosure. As shown, during a first processing stage, the diffusion model 102 may process first input data 504(1) associated with the first segment 304(1) of the audio 302. In some examples, the first input data 504(1) may represent at least one or more first noisy frames (e.g., the first and second frames from the example of FIGS. 4A-4D), the first portion of the audio 302, a timestep, an identity of the character 502, and a first emotional state. As such, based at least on processing the first input data 504(1), the diffusion model 102 may generate at least a first denoised frame 506(1) representing an animation of the character 502. In some examples, the first denoised frame 506(1) may then be presented to one or more users.

Next, during a second processing stage, the diffusion model 102 may process second input data 504(2) associated with the second segment 304(2) of the audio 302. In some examples, the second input data 504(2) may represent at least one or more second noisy frames (e.g., the third and fourth frames from the example of FIGS. 4A-4D), the second portion of the audio 302, the timestep, the identity of the character 502, and a second emotional state. As such, based at least on processing the second input data 504(2), the diffusion model 102 may generate at least a second denoised frame 506(2) representing an animation of the character 502. In some examples, the second processing stage may occur at least partially while the first denoised frame 506(1) is being presented to the user(s). Additionally, the second denoised frame 506(2) may be presented after the first denoised frame 506(1) such that the character 502 is continually animated as the diffusion model 102 continues processing input data during the different processing stages.

In the example of FIG. 5, the first emotional state represented by the first input data 504(1) may differ from the second emotional state represented by the second input data 504(2). As such, and as shown, the emotions of the character 502 may be updated during the animation in order to reflect the different emotional states. For example, the first denoised frame 506(1) may represent the character 502 using a neutral emotional state while the second denoised frame 506(2) represents the character using a happy emotional state.

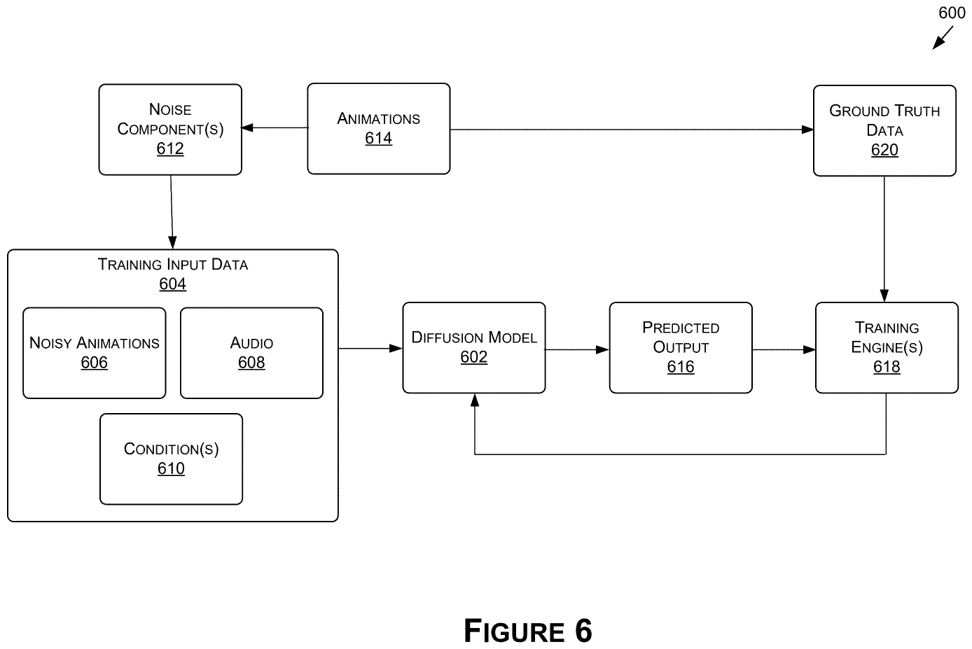

FIG. 6 illustrates an example data flow diagram for a process 600 of training a diffusion model 602 (which may include, and/or be similar to, the diffusion model 102) to perform audio-drive character animation, in accordance with some embodiments of the present disclosure. As shown, the diffusion model 602 may be trained using training input data 604 that represents at least noisy animations 606 of one or more characters (e.g., noisy frames representing the noisy animations 606 of the character(s)), audio 608, and one or more additional conditions 610. In some examples, the noisy animations 606 may be generated using one or more noise components 612 that add the noise to clean animations 614 of the character(s) (e.g., denoised frames representing the clean animations 614 of the character(s)), using one or more of the processes described herein. Additionally, the sound 608 may represent instances of speech associated with the animations of the character(s). Furthermore, the condition(s) 610 may include one or more identifiers of the character(s), one or more timesteps, and/or one or more emotional states, similar to the input data 104 described herein.

The process 600 may include the diffusion model 602 processing the training input data 604 to generate output data representing predicted animations 616 (e.g., frames representing the predicted animations 616). In some examples, the diffusion model 602 may perform one or more of the processes described herein to process the training input data 604 and generate the predicted animations 616. For instance, the diffusion model 602 may process the training input data 604 using an entirety of the audio 608 in a single processing stage, by segmenting the audio 608 into segments for multiple processing stages, and/or using any other technique. Additionally, in some examples, the diffusion model 602 may include a similar architecture as the diffusion model 102—such as the architecture illustrated in the example of FIGS. 2A-2B—that is used to process the training input data 604.

The process 600 may then include one or more training engines 618 using one or more loss functions that measure loss (e.g., error) in the output data by at least comparing the predicted animations 616 to the clean animations 614 associated with ground truth data 620. For instance, in some examples, the loss function(s) may measure the loss based at least on differences between the predicted animations 616 and the clean animations 614. As described herein, the training engine(s) 618 may use any type of loss function to measure the loss, such as KL divergence loss, mean squared error, cross-entropy loss, mean absolute error, and/or the like. The training engine(s) 618 may then perform backward pass computations to recursively compute gradients of the loss function(s) with respect to training parameters in order to update the parameters and/or weights of the diffusion model 602.

For instance, during the training of the diffusion model 602, the process 600 may use the following equations:

$${x}_{0} ∼ q ( {x}_{0} ) \qquad ( 4 )$$

$$t ∼ Uniform ( \{ 1 , … , T \} ) \qquad ( 5 )$$

$$ε ∼ N ( 0 , I ) \qquad ( 6 )$$

$${x}_{t} = \sqrt{{\overline{α}}_{t}} \cdot {x}_{0} + \sqrt{1 - {\overline{α}}_{t}} \cdot ε \qquad ( 7 )$$

In equations (4)-(7), q(x₀) is a training dataset distribution such that the training includes sampling the clean animations from the training dataset distribution. Additionally, the training engine(s) 618 may then be configured to take the gradient descent step on ∇_{θ}∥x₀−θ(xₜ, t)∥² until throughout convergence.

In some examples, such as to increase the performance of the diffusion model 602 for real-time and/or near real-time applications, the process 600 may include cropping the training input data 604 to one or more random lengths—such as between 0.5 seconds and 10 seconds (and/or any other lengths)—and then performing the training on the segments. For instance, by using such a technique during the training, the diffusion model 602 may adapt better for short audio buffer and animations that the diffusion model 602 may use when processing data during inference.

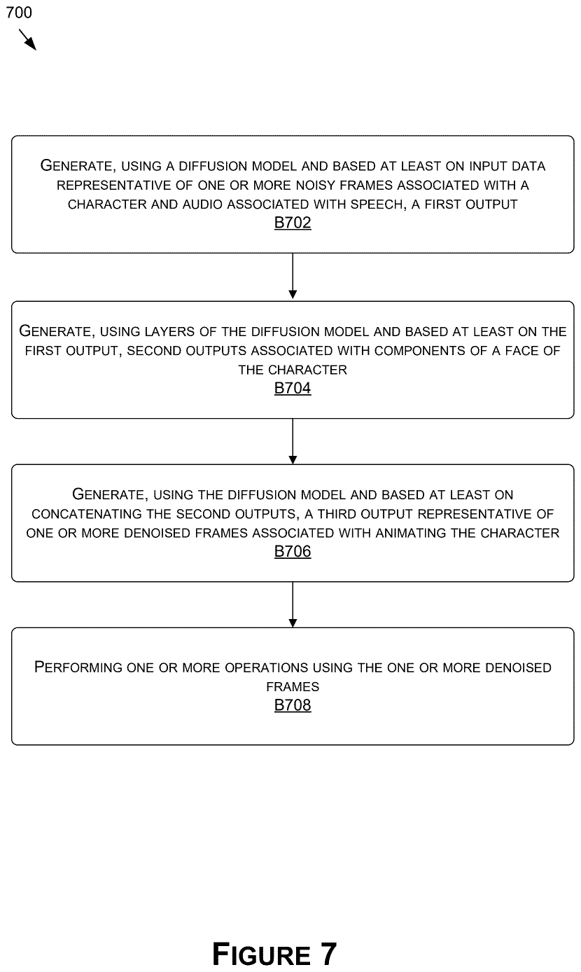

Now referring to FIGS. 7-9, each block of methods 700, 800, and 900, described herein, comprises a computing process that may be performed using any combination of hardware, firmware, and/or software. For instance, various functions may be carried out by a processor executing instructions stored in memory. The methods 700, 800, and 900 may also be embodied as computer-usable instructions stored on computer storage media. The methods 700, 800, and 900 may be provided by a standalone application, a service or hosted service (standalone or in combination with another hosted service), or a plug-in to another product, to name a few. In addition, these methods 700, 800, and 900 described, by way of example, with respect to FIGS. 2A-2B. However, these methods 700, 800, and 900 may additionally or alternatively be executed by any one system, or any combination of systems, including, but not limited to, those described herein.

FIG. 7 illustrates a flow diagram showing a method 700 for using a diffusion model that denoises multiple components together when animating a character, in accordance with some embodiments of the present disclosure. The method 700, at block B702, may include generating, using a diffusion model and based at least on input data representative of one or more noisy frames associated with a character and audio associated with speech, a first output. For instance, the diffusion model 102 may process the input data 202 representing at least the noisy frame(s) 206 and the audio 204 using the encoder(s) 214 to generate the output 228. The diffusion model 102 may then process the output 228 using the layer(s) 230 to generate the output 236.

The method 700, at block B704, may include generating, using layers of the diffusion model and based at least on the first output, second outputs associated with components of a face of the character. For instance, the diffusion model 102 may process the output 236 using the decoder(s) 234—such as the face head 238, the tongue head 242, the gum head 246, and/or the eye head 250—to generate the outputs 240, 244, 248, and/or 252 associated with the components of the character. As described herein, in some examples, the components may include the face, the tongue, the gums, and/or the eyes.

The method 700, at block B706, may include generating, using the diffusion model and based at least on concatenating the second outputs, a third output representative of one or more denoised frames associated with animating the character. For instance, the diffusion model 102 may process the outputs 240, 244, 248, and/or 252 using the decoder(s) 234, such as by concatenating the outputs 240, 244, 248, and/or the 252 to generate the output 756. The diffusion model 102 may further use the decoder(s) 234 to process the output 256 with respect to the template 260 of the character—such as by adding the output 256 to the template 260—to generate the denoised frame(s) 262 associated with animating the character.

The method 700, at block B708, may include performing one or more operations using the one or more denoised frames. For instance, data representing the denoised frame(s) 262 may be stored in one or more databases, the data may be sent to one or more user devices, the denoised frame(s) 262 may be displayed to one or more users, and/or any other type of operation may be performed.

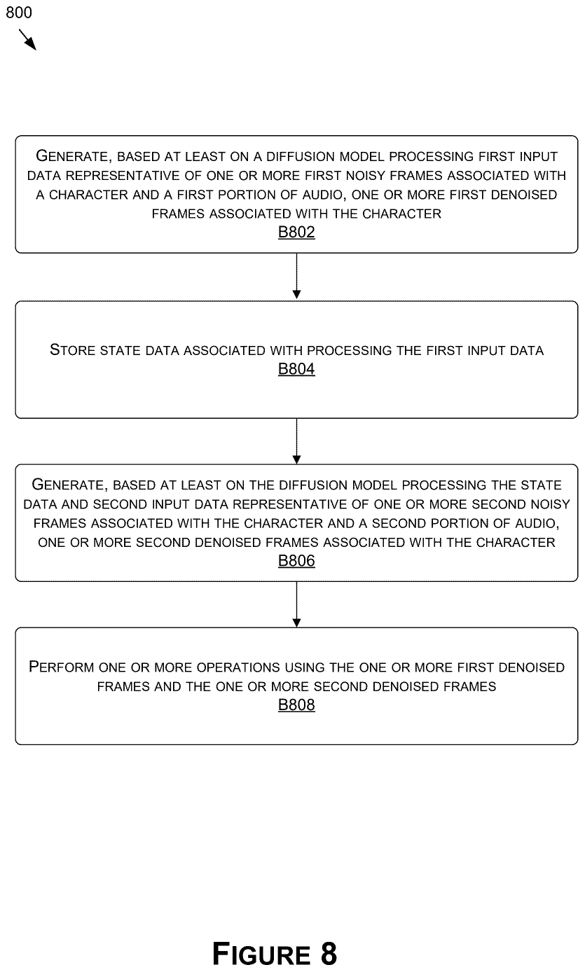

FIG. 8 illustrates a flow diagram showing a method 800 for using a diffusion model to process audio in segments when animating a character, in accordance with some embodiments of the present disclosure. The method 800, at block B802, may include generating, based at least on a diffusion model processing first input data representative of one or more first noisy frames associated with a character and a first portion of audio, one or more first denoised frames associated with the character. For instance, the diffusion model 102 may process the first input data 202 representing at least the first noisy frame(s) 206 and the first portion of the audio 204. In some examples, the first input data 202 may further represent the timestep 208, the identifier 210, and/or a first emotional state 212. Based at least on the processing, the diffusion model 102 may generate the first denoised frame(s) 262 associated with animating the character.

The method 800, at block B804, may include storing state data associated with processing the first input data. For instance, the diffusion model 102 may store the state data 232 associated with processing the first input data 202. As described herein, in some examples, the state data 232 may represent one or more hidden states—such as one or more latent variables—associated with processing the first input data 202.

The method 800, at block B806, may include generating, based at least on the diffusion model processing the state data and second input data representative of one or more second noisy frames associated with the character and a second portion of the audio, one or more second denoised frames associated with the character. For instance, the diffusion model 102 may process the state data 232 and the second input data 202 representing at least the second noisy frame(s) 206 and the second portion of the audio 204. In some examples, the second input data 202 may further represent the timestep 208, the identifier 210, and/or a second emotional state 212. Based at least on the processing, the diffusion model 102 may generate the second denoised frame(s) 262 associated with animating the character.

The method 800, at block B808, may include performing one or more operations using the one or more first denoised frames and the one or more second denoised frames. For instance, data representing the first denoised frame(s) 262 followed by the second denoised frame(s) 262 may be stored in one or more databases, the data may be sent to one or more user devices, the first denoised frame(s) 262 may be displayed followed by the second denoised frame(s) 262, and/or any other type of operation may be performed.

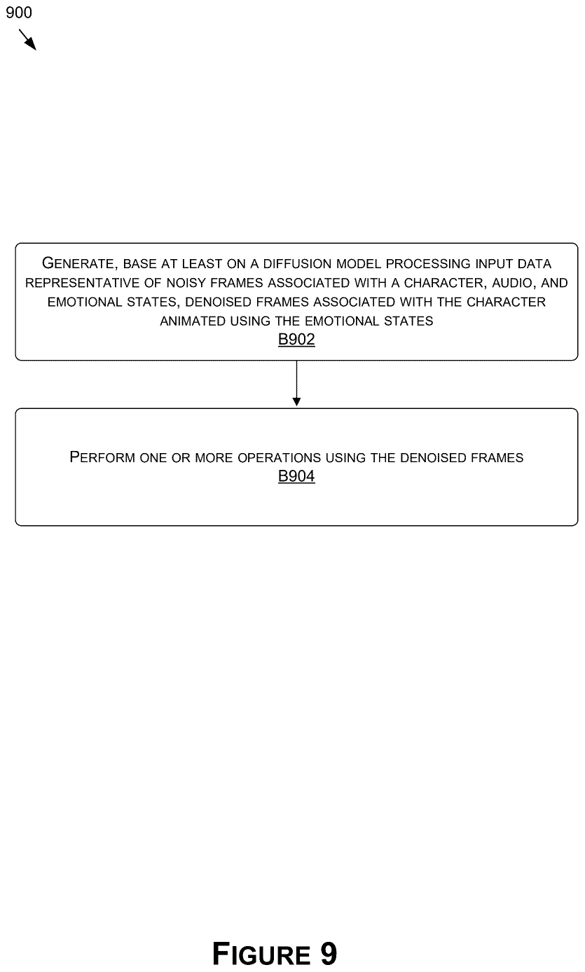

FIG. 9 illustrates a flow diagram showing a method 900 for using a diffusion model to animate a character using different emotional states, in accordance with some embodiments of the present disclosure. The method 900, at block B902, may include generating, based at least on a diffusion model processing input data representative of noisy frames associated with a character, audio, and emotional states, denoising frames associated with the character animated using the emotional states. For instance, the diffusion model 102 may process the input data 202 representing at least the noisy frames 206, the audio 204, and the emotional states 212. As described herein, individual frames and/or groups of frames may be associated with a respective emotional state 212. Based at least on processing the input data, the diffusion model 102 may generate the denoised frames 262 associated with the character animated using the emotional states 212. For instance, in some examples, the character may be animated using different emotions.

The method 900, at block B904, may include performing one or more operations using the denoised frames. For instance, data representing the denoised frame(s) 262 may be stored in one or more databases, the data may be sent to one or more user devices, the denoised frame(s) 262 may be displayed to one or more users, and/or any other type of operation may be performed.

### Example Computing Device

FIG. 10 is a block diagram of an example computing device(s) 1000 suitable for use in implementing some embodiments of the present disclosure. Computing device 1000 may include an interconnect system 1002 that directly or indirectly couples the following devices: memory 1004, one or more central processing units (CPUs) 1006, one or more graphics processing units (GPUs) 1008, a communication interface 1010, input/output (I/O) ports 1012, input/output components 1014, a power supply 1016, one or more presentation components 1018 (e.g., display(s)), and one or more logic units 1020. In at least one embodiment, the computing device(s) 1000 may comprise one or more virtual machines (VMs), and/or any of the components thereof may comprise virtual components (e.g., virtual hardware components). For non-limiting examples, one or more of the GPUs 1008 may comprise one or more vGPUs, one or more of the CPUs 1006 may comprise one or more vCPUs, and/or one or more of the logic units 1020 may comprise one or more virtual logic units. As such, a computing device(s) 1000 may include discrete components (e.g., a full GPU dedicated to the computing device 1000), virtual components (e.g., a portion of a GPU dedicated to the computing device 1000), or a combination thereof.

Although the various blocks of FIG. 10 are shown as connected via the interconnect system 1002 with lines, this is not intended to be limiting and is for clarity only. For example, in some embodiments, a presentation component 1018, such as a display device, may be considered an I/O component 1014 (e.g., if the display is a touch screen). As another example, the CPUs 1006 and/or GPUs 1008 may include memory (e.g., the memory 1004 may be representative of a storage device in addition to the memory of the GPUs 1008, the CPUs 1006, and/or other components). In other words, the computing device of FIG. 10 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 10.

The interconnect system 1002 may represent one or more links or busses, such as an address bus, a data bus, a control bus, or a combination thereof. The interconnect system 1002 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 1006 may be directly connected to the memory 1004. Further, the CPU 1006 may be directly connected to the GPU 1008. Where there is direct, or point-to-point connection between components, the interconnect system 1002 may include a PCIe link to carry out the connection. In these examples, a PCI bus need not be included in the computing device 1000.

The memory 1004 may include any of a variety of computer-readable media. The computer-readable media may be any available media that may be accessed by the computing device 1000. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 1004 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 1000. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 1006 may be configured to execute at least some of the computer-readable instructions to control one or more components of the computing device 1000 to perform one or more of the methods and/or processes described herein. The CPU(s) 1006 may each include one or more cores (e.g., one, two, four, eight, twenty-eight, seventy-two, etc.) that are capable of handling a multitude of software threads simultaneously. The CPU(s) 1006 may include any type of processor, and may include different types of processors depending on the type of computing device 1000 implemented (e.g., processors with fewer cores for mobile devices and processors with more cores for servers). For example, depending on the type of computing device 1000, the processor may be an Advanced RISC Machines (ARM) processor implemented using Reduced Instruction Set Computing (RISC) or an x86 processor implemented using Complex Instruction Set Computing (CISC). The computing device 1000 may include one or more CPUs 1006 in addition to one or more microprocessors or supplementary co-processors, such as math co-processors.

In addition to or alternatively from the CPU(s) 1006, the GPU(s) 1008 may be configured to execute at least some of the computer-readable instructions to control one or more components of the computing device 1000 to perform one or more of the methods and/or processes described herein. One or more of the GPU(s) 1008 may be an integrated GPU (e.g., with one or more of the CPU(s) 1006 and/or one or more of the GPU(s) 1008 may be a discrete GPU. In embodiments, one or more of the GPU(s) 1008 may be a coprocessor of one or more of the CPU(s) 1006. The GPU(s) 1008 may be used by the computing device 1000 to render graphics (e.g., 3D graphics) or perform general purpose computations. For example, the GPU(s) 1008 may be used for General-Purpose computing on GPUs (GPGPU). The GPU(s) 1008 may include hundreds or thousands of cores that are capable of handling hundreds or thousands of software threads simultaneously. The GPU(s) 1008 may generate pixel data for output images in response to rendering commands (e.g., rendering commands from the CPU(s) 1006 received via a host interface). The GPU(s) 1008 may include graphics memory, such as display memory, for storing pixel data or any other suitable data, such as GPGPU data. The display memory may be included as part of the memory 1004. The GPU(s) 1008 may include two or more GPUs operating in parallel (e.g., via a link). The link may directly connect the GPUs (e.g., using NVLINK) or may connect the GPUs through a switch (e.g., using NVSwitch). When combined together, each GPU 1008 may generate pixel data or GPGPU data for different portions of an output or for different outputs (e.g., a first GPU for a first image and a second GPU for a simulated image). Each GPU may include its own memory, or may share memory with other GPUs.

In addition to or alternatively from the CPU(s) 1006 and/or the GPU(s) 1008, the logic unit(s) 1020 may be configured to execute at least some of the computer-readable instructions to control one or more components of the computing device 1000 to perform one or more of the methods and/or processes described herein. In embodiments, the CPU(s) 1006, the GPU(s) 1008, and/or the logic unit(s) 1020 may discretely or jointly perform any combination of the methods, processes and/or portions thereof. One or more of the logic units 1020 may be part of and/or integrated in one or more of the CPU(s) 1006 and/or the GPU(s) 1008 and/or one or more of the logic units 1020 may be discrete components or otherwise external to the CPU(s) 1006 and/or the GPU(s) 1008. In embodiments, one or more of the logic units 1020 may be a coprocessor of one or more of the CPU(s) 1006 and/or one or more of the GPU(s) 1008.

Examples of the logic unit(s) 1020 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 1010 may include one or more receivers, transmitters, and/or transceivers that enable the computing device 1000 to communicate with other computing devices via an electronic communication network, included wired and/or wireless communications. The communication interface 1010 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 1020 and/or communication interface 1010 may include one or more data processing units (DPUs) to transmit data received over a network and/or through interconnect system 1002 directly to (e.g., a memory of) one or more GPU(s) 1008.

The I/O ports 1012 may enable the computing device 1000 to be logically coupled to other devices including the I/O components 1014, the presentation component(s) 1018, and/or other components, some of which may be built in to (e.g., integrated in) the computing device 1000. Illustrative I/O components 1014 include a microphone, mouse, keyboard, joystick, game pad, game controller, satellite dish, scanner, printer, wireless device, etc. The I/O components 1014 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 1000. The computing device 1000 may be include depth cameras, such as stereoscopic camera systems, infrared camera systems, RGB camera systems, touchscreen technology, and combinations of these, for gesture detection and recognition. Additionally, the computing device 1000 may include accelerometers or gyroscopes (e.g., as part of an inertia measurement unit (IMU)) that enable detection of motion. In some examples, the output of the accelerometers or gyroscopes may be used by the computing device 1000 to render immersive augmented reality or virtual reality.

The power supply 1016 may include a hard-wired power supply, a battery power supply, or a combination thereof. The power supply 1016 may provide power to the computing device 1000 to enable the components of the computing device 1000 to operate.

The presentation component(s) 1018 may include a display (e.g., a monitor, a touch screen, a television screen, a heads-up-display (HUD), other display types, or a combination thereof), speakers, and/or other presentation components. The presentation component(s) 1018 may receive data from other components (e.g., the GPU(s) 1008, the CPU(s) 1006, DPUs, etc.), and output the data (e.g., as an image, video, sound, etc.).

### Example Data Center

FIG. 11 illustrates an example data center 1100 that may be used in at least one embodiments of the present disclosure. The data center 1100 may include a data center infrastructure layer 1110, a framework layer 1120, a software layer 1130, and/or an application layer 1140.

As shown in FIG. 11, the data center infrastructure layer 1110 may include a resource orchestrator 1112, grouped computing resources 1114, and node computing resources (“node C.R.s”) 1116(1)-1116(N), where “N” represents any whole, positive integer. In at least one embodiment, node C.R.s 1116(1)-1116(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 1116(1)-1116(N) may correspond to a server having one or more of the above-mentioned computing resources. In addition, in some embodiments, the node C.R.s 1116(1)-11161(N) may include one or more virtual components, such as vGPUs, vCPUs, and/or the like, and/or one or more of the node C.R.s 1116(1)-1116(N) may correspond to a virtual machine (VM).

In at least one embodiment, grouped computing resources 1114 may include separate groupings of node C.R.s 1116 housed within one or more racks (not shown), or many racks housed in data centers at various geographical locations (also not shown). Separate groupings of node C.R.s 1116 within grouped computing resources 1114 may include grouped compute, network, memory or storage resources that may be configured or allocated to support one or more workloads. In at least one embodiment, several node C.R.s 1116 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 1112 may configure or otherwise control one or more node C.R.s 1116(1)-1116(N) and/or grouped computing resources 1114. In at least one embodiment, resource orchestrator 1112 may include a software design infrastructure (SDI) management entity for the data center 1100. The resource orchestrator 1112 may include hardware, software, or some combination thereof.

In at least one embodiment, as shown in FIG. 11, framework layer 1120 may include a job scheduler 1133, a configuration manager 1134, a resource manager 1136, and/or a distributed file system 1138. The framework layer 1120 may include a framework to support software 1132 of software layer 1130 and/or one or more application(s) 1142 of application layer 1140. The software 1132 or application(s) 1142 may respectively include web-based service software or applications, such as those provided by Amazon Web Services, Google Cloud and Microsoft Azure. The framework layer 1120 may be, but is not limited to, a type of free and open-source software web application framework such as Apache Spark™ (hereinafter “Spark”) that may utilize distributed file system 1138 for large-scale data processing (e.g., “big data”). In at least one embodiment, job scheduler 1133 may include a Spark driver to facilitate scheduling of workloads supported by various layers of data center 1100. The configuration manager 1134 may be capable of configuring different layers such as software layer 1130 and framework layer 1120 including Spark and distributed file system 1138 for supporting large-scale data processing. The resource manager 1136 may be capable of managing clustered or grouped computing resources mapped to or allocated for support of distributed file system 1138 and job scheduler 1133. In at least one embodiment, clustered or grouped computing resources may include grouped computing resource 1114 at data center infrastructure layer 1110. The resource manager 1136 may coordinate with resource orchestrator 1112 to manage these mapped or allocated computing resources.

In at least one embodiment, software 1132 included in software layer 1130 may include software used by at least portions of node C.R.s 1116(1)-1116(N), grouped computing resources 1114, and/or distributed file system 1138 of framework layer 1120. One or more types of software may include, but are not limited to, Internet web page search software, e-mail virus scan software, database software, and streaming video content software.

In at least one embodiment, application(s) 1142 included in application layer 1140 may include one or more types of applications used by at least portions of node C.R.s 1116(1)-1116(N), grouped computing resources 1114, and/or distributed file system 1138 of framework layer 1120. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 1134, resource manager 1136, and resource orchestrator 1112 may implement any number and type of self-modifying actions based on any amount and type of data acquired in any technically feasible fashion. Self-modifying actions may relieve a data center operator of data center 1100 from making possibly bad configuration decisions and possibly avoiding underutilized and/or poor performing portions of a data center.

The data center 1100 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 1100. In at least one embodiment, trained or deployed machine learning models corresponding to one or more neural networks may be used to infer or predict information using resources described above with respect to the data center 1100 by using weight parameters calculated through one or more training techniques, such as but not limited to those described herein.

In at least one embodiment, the data center 1100 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 1000 of FIG. 10—e.g., each device may include similar components, features, and/or functionality of the computing device(s) 1000. In addition, where backend devices (e.g., servers, NAS, etc.) are implemented, the backend devices may be included as part of a data center 1100, an example of which is described in more detail herein with respect to FIG. 11.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment- and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 1000 described herein with respect to FIG. 10. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

### Example Paragraphs

A: A method comprising: generating a first representation using a diffusion model and based at least on input data representative of one or more frames associated with a character and audio data associated with a portion of speech; generating, using one or more layers of the diffusion model and based at least on the first representation, second representations of one or more components of a face of the character; generating, using the diffusion model and based at least on concatenating the second representations, one or more denoised frames depicting an animation of a pronunciation by the character of the portion of speech; and causing output of the one or more denoised frames.
B: The method of paragraph A, further comprising: storing state data representative of one or more states associated with processing the input data; generating, using the diffusion model and based at least on the state data and second input data representative of at least one or more second frames associated with the character and second audio data associated with a second portion of speech, a representation of one or more second denoised frames depicting an animation of a pronunciation by the character of the portion second speech; and causing output of the one or more second denoised frames after the output of the one or more denoised frames.
C: The method of paragraph B, further comprising: segmenting third audio data into at least a first portion corresponding to the audio data and a second portion corresponding to the second audio data; applying, at a first time and based at least on the segmenting, the input data to the diffusion model that represents the first audio data; and applying, at a second time and based at least on the segmenting, the second input data to the diffusion model that represents the second audio data.
D: The method of any one of paragraphs A-C, wherein: the input data represents a first emotional state associated with a first noisy frame of the one or more noisy frames and a second emotional state associated with a second noisy frame of the one or more noisy frames; and a first denoised frame of the one or more denoised frames depicts the character expressing the first emotional state and a second denoised frame of the one or more denoised frames depicts the character expressing the second emotional state.
E: The method of any one of paragraphs A-D, further comprising: generating, using the diffusion model and based at least on second input data representative of at least the one or more denoised frames and the audio data associated with the portion of speech, one or more second denoised frames depicting an animation by the character of a pronunciation of the portion of speech, wherein the causing the output includes causing the one or more second denoised frames to be presented.
F: The method of any one of paragraphs A-E, further comprising: determining a number of diffusion steps associated with processing the input data using the diffusion model, the number of diffusion steps being less than or equal to ten, wherein the generating the one or more denoised frames is further based at least on the number of diffusion steps.
G: The method of any one of paragraphs A-F, wherein: the input data is further representative of an identifier associated with the character; and the generating the one or more denoised frames is further based at least on adding a template associated with the character to the second representations.
H: The method of any one of paragraphs A-G, wherein: the one or more frames include at least a first noisy frame and a second noisy frame; and the one or more denoised frames include at least a first denoised frame associated with the first noisy frame and a second denoised frame associated with the second noisy frame.
I: A system comprising: one or more processors to: generate, based at least on a diffusion model processing first input data including one or more first frames associated with a subject and a first portion of audio data, one or more first denoised frames associated with an animation of the subject; store state data associated with processing the first input data; generate, based at least on the diffusion model processing the state data and second input data including one or more second frames associated with the subject and a second portion of the audio data, one or more second denoised frames associated with the animation of the subject; and perform one or more operations using at least the one or more first denoised frames and the one or more second denoised frames.
J: The system of paragraph I, wherein: the first input data further includes a first emotional state associated with the one or more first noisy frames; the one or more first denoised frames depict the subject as expressing the first emotional state; the second input data further includes a second emotional state associated with the one or more second noisy frames; and the one or more second denoised frames depict the subject as expressing the second emotional state.
K: The system of either paragraph I or paragraph J, wherein the one or more processors are further to: segment the audio into the first portion of the audio data and the second portion of the audio data; apply, at a first time, the first input data to the diffusion model that represents the first portion of the audio data; and apply, at a second time, the second input data to the diffusion model that represents the second portion of the audio data.
L: The system of any one of paragraphs I-K, wherein the generation of the one or more first denoised frames comprises: generating, using layers of the diffusion model and based at least on the first input data, first outputs associated with components of a face of the subject; and generating, using the diffusion model and based at least on concatenating the first outputs, a second output representative of one or more first denoised frames associated with an animation of the subject.
M: The system of any one of paragraphs I-L, wherein: the generation of the one or more first denoised frames comprises: generating, based at least on the diffusion model processing the first input data, one or more first initial denoised frames depicting a first animation of the subject; and generating, based at least on the diffusion model processing third input data representative of the one or more first initial denoised frames and the first portion of the audio data, the one or more first denoised frames depicting a first animation of the subject; and the generation of the one or more second denoised frames comprises: generating, based at least on the diffusion model processing a first portion of the state data and the second input data, one or more second initial denoised frames depicting a second animation of the subject; and generating, based at least on the diffusion model processing a second portion of the state data and fourth input data representative of the one or more second initial denoised frames and the second portion of the audio data, the one or more second denoised frames depicting a second animation of the subject.
N: The system of any one of paragraphs I-M, wherein the one or more processors are further to: determine a number of diffusion steps associated with processing using the diffusion model, the number of diffusion steps being less than or equal to ten, wherein the one or more first denoised frames and the one or more second denoised drafts are generated based at least on the number of diffusion steps.
O: The system of any one of paragraphs I-N, wherein: the one or more first frames include at least a first noisy frame and a second noisy frame; the one or more first denoised frames include at least a first denoised frame associated with the first noisy fame and a second denoised frame associated with the second noisy frame; the one or more second frames include at least a third noisy frame and a fourth noisy frame; and the one or more second denoised frames include at least a third denoised frame associated with the third noisy fame and a fourth denoised frame associated with the fourth noisy frame.
P: The system of any one of paragraphs I-O, wherein: the first input data and the second input data further represent an identifier associated with the subject; the one or more first denoised frames are further generated based at least on a template associated with the identifier; and the one or more second denoised frames are further generated based at least on the template.
Q: The system of any one of paragraphs I-P, wherein the performance of the one or more operations comprises at least one of: storing data representative of the one or more first denoised frames followed by the one or more second denoised frames; or causing output of the one or more first denoised frames followed by the one or more second denoised frames.
R: The system of any one of paragraphs I-Q, wherein the system is comprised in at least one of: a control system for an autonomous or semi-autonomous machine; a perception system for an autonomous or semi-autonomous machine; a system for performing one or more simulation operations; a system for performing one or more digital twin operations; a system for performing light transport simulation; a system for performing collaborative content creation for 3D assets; a system that provides one or more cloud gaming applications; a system for performing one or more deep learning operations; a system implemented using an edge device; a system implemented using a robot; a system for performing one or more generative AI operations; a system for performing operations using one or more large language models (LLMs); a system for performing operations using one or more vision language models (VLMs); a system for performing operations using one or more multi-modal language models; a system for performing one or more conversational AI operations; a system for generating synthetic data; a system for presenting at least one of virtual reality content, augmented reality content, or mixed reality content; systems implementing one or more multi-modal language models; systems using or deploying one or more inference microservices; systems that incorporate deploy one or more machine learning models in a service or microservice along with an OS-level virtualization package (e.g., a container); a system incorporating one or more virtual machines (VMs); a system implemented at least partially in a data center; or a system implemented at least partially using cloud computing resources.
S: One or more processors comprising: processing circuitry to: obtain input data representative of one or more first frames, audio data, a first emotional state associated with a first portion of the one or more first frames, and a second emotional state associated with a second portion of the one or more first frames; generate, using a diffusion model and based on the input data, denoised frames associated with the one or more first frames, a first portion of the denoised frames depicting an animation of the character as vocalizing a first portion of the audio data and expressing the first emotional state and a second portion of the denoised frames depicting an animation of the character as vocalizing a second portion of the audio and expressing the second emotional state; and perform one or more operations using the one or more denoised frames.
T: The one or more processors of paragraph S, wherein the one or more processors are comprised in at least one of: a control system for an autonomous or semi-autonomous machine; a perception system for an autonomous or semi-autonomous machine; a system for performing one or more simulation operations; a system for performing one or more digital twin operations; a system for performing light transport simulation; a system for performing collaborative content creation for 3D assets; a system that provides one or more cloud gaming applications; a system for performing one or more deep learning operations; a system implemented using an edge device; a system implemented using a robot; a system for performing one or more generative AI operations; a system for performing operations using one or more large language models (LLMs); a system for performing operations using one or more vision language models (VLMs); a system for performing operations using one or more multi-modal language models; a system for performing one or more conversational AI operations; a system for generating synthetic data; a system for presenting at least one of virtual reality content, augmented reality content, or mixed reality content; systems implementing one or more multi-modal language models; systems using or deploying one or more inference microservices; systems that incorporate deploy one or more machine learning models in a service or microservice along with an OS-level virtualization package (e.g., a container); a system incorporating one or more virtual machines (VMs); a system implemented at least partially in a data center; or a system implemented at least partially using cloud computing resources.

What is claimed is:

1. A method comprising:
generating a first representation using a diffusion model and based at least on input data representative of one or more frames associated with a character and audio data associated with a portion of speech;
generating, using one or more layers of the diffusion model and based at least on the first representation, second representations of one or more components of a face of the character;
generating, using the diffusion model and based at least on concatenating the second representations, one or more denoised frames depicting an animation of a pronunciation by the character of the portion of speech; and
causing output of the one or more denoised frames.

2. The method of claim 1, further comprising:
storing state data representative of one or more states associated with processing the input data;
generating, using the diffusion model and based at least on the state data and second input data representative of at least one or more second frames associated with the character and second audio data associated with a second portion of speech, a representation of one or more second denoised frames depicting an animation of a pronunciation by the character of the portion second speech; and
causing output of the one or more second denoised frames after the output of the one or more denoised frames.

3. The method of claim 2, further comprising:
segmenting third audio data into at least a first portion corresponding to the audio data and a second portion corresponding to the second audio data;
applying, at a first time and based at least on the segmenting, the input data to the diffusion model that represents the first audio data; and
applying, at a second time and based at least on the segmenting, the second input data to the diffusion model that represents the second audio data.

4. The method of claim 1, wherein:
the input data represents a first emotional state associated with a first noisy frame of the one or more noisy frames and a second emotional state associated with a second noisy frame of the one or more noisy frames; and
a first denoised frame of the one or more denoised frames depicts the character expressing the first emotional state and a second denoised frame of the one or more denoised frames depicts the character expressing the second emotional state.

5. The method of claim 1, further comprising:
generating, using the diffusion model and based at least on second input data representative of at least the one or more denoised frames and the audio data associated with the portion of speech, one or more second denoised frames depicting an animation by the character of a pronunciation of the portion of speech,
wherein the causing the output includes causing the one or more second denoised frames to be presented.

6. The method of claim 1, further comprising:
determining a number of diffusion steps associated with processing the input data using the diffusion model, the number of diffusion steps being less than or equal to ten,
wherein the generating the one or more denoised frames is further based at least on the number of diffusion steps.

7. The method of claim 1, wherein:
the input data is further representative of an identifier associated with the character; and
the generating the one or more denoised frames is further based at least on adding a template associated with the character to the second representations.

8. The method of claim 1, wherein:
the one or more frames include at least a first noisy frame and a second noisy frame; and
the one or more denoised frames include at least a first denoised frame associated with the first noisy frame and a second denoised frame associated with the second noisy frame.

9. A system comprising:
one or more processors to:
generate, based at least on a diffusion model processing first input data including one or more first frames associated with a subject and a first portion of audio data, one or more first denoised frames associated with an animation of the subject;
store state data associated with processing the first input data;
generate, based at least on the diffusion model processing the state data and second input data including one or more second frames associated with the subject and a second portion of the audio data, one or more second denoised frames associated with the animation of the subject; and
perform one or more operations using at least the one or more first denoised frames and the one or more second denoised frames.

10. The system of claim 9, wherein:
the first input data further includes a first emotional state associated with the one or more first noisy frames;
the one or more first denoised frames depict the subject as expressing the first emotional state;
the second input data further includes a second emotional state associated with the one or more second noisy frames; and
the one or more second denoised frames depict the subject as expressing the second emotional state.

11. The system of claim 9, wherein the one or more processors are further to:
segment the audio into the first portion of the audio data and the second portion of the audio data;
apply, at a first time, the first input data to the diffusion model that represents the first portion of the audio data; and
apply, at a second time, the second input data to the diffusion model that represents the second portion of the audio data.

12. The system of claim 9, wherein the generation of the one or more first denoised frames comprises:
generating, using layers of the diffusion model and based at least on the first input data, first outputs associated with components of a face of the subject; and
generating, using the diffusion model and based at least on concatenating the first outputs, a second output representative of one or more first denoised frames associated with an animation of the subject.

13. The system of claim 9, wherein:
the generation of the one or more first denoised frames comprises:
generating, based at least on the diffusion model processing the first input data, one or more first initial denoised frames depicting a first animation of the subject; and
generating, based at least on the diffusion model processing third input data representative of the one or more first initial denoised frames and the first portion of the audio data, the one or more first denoised frames depicting a first animation of the subject; and
the generation of the one or more second denoised frames comprises:
generating, based at least on the diffusion model processing a first portion of the state data and the second input data, one or more second initial denoised frames depicting a second animation of the subject; and
generating, based at least on the diffusion model processing a second portion of the state data and fourth input data representative of the one or more second initial denoised frames and the second portion of the audio data, the one or more second denoised frames depicting a second animation of the subject.

14. The system of claim 9, wherein the one or more processors are further to:
determine a number of diffusion steps associated with processing using the diffusion model, the number of diffusion steps being less than or equal to ten,
wherein the one or more first denoised frames and the one or more second denoised drafts are generated based at least on the number of diffusion steps.

15. The system of claim 9, wherein:
the one or more first frames include at least a first noisy frame and a second noisy frame;
the one or more first denoised frames include at least a first denoised frame associated with the first noisy fame and a second denoised frame associated with the second noisy frame;
the one or more second frames include at least a third noisy frame and a fourth noisy frame; and
the one or more second denoised frames include at least a third denoised frame associated with the third noisy fame and a fourth denoised frame associated with the fourth noisy frame.

16. The system of claim 9, wherein:
the first input data and the second input data further represent an identifier associated with the subject;
the one or more first denoised frames are further generated based at least on a template associated with the identifier; and
the one or more second denoised frames are further generated based at least on the template.

17. The system of claim 9, wherein the performance of the one or more operations comprises at least one of:
storing data representative of the one or more first denoised frames followed by the one or more second denoised frames; or
causing output of the one or more first denoised frames followed by the one or more second denoised frames.

18. The system of claim 9, wherein the system is comprised in at least one of:
a control system for an autonomous or semi-autonomous machine;
a perception system for an autonomous or semi-autonomous machine;
a system for performing one or more simulation operations;
a system for performing one or more digital twin operations;
a system for performing light transport simulation;
a system for performing collaborative content creation for 3D assets;
a system that provides one or more cloud gaming applications;
a system for performing one or more deep learning operations;
a system implemented using an edge device;
a system implemented using a robot;
a system for performing one or more generative AI operations;
a system for performing operations using one or more large language models (LLMs);
a system for performing operations using one or more vision language models (VLMs);
a system for performing operations using one or more multi-modal language models;
a system for performing one or more conversational AI operations;
a system for generating synthetic data;
a system for presenting at least one of virtual reality content, augmented reality content, or mixed reality content;
systems implementing one or more multi-modal language models;
systems using or deploying one or more inference microservices;
systems that incorporate deploy one or more machine learning models in a service or microservice along with an OS-level virtualization package (e.g., a container);
a system incorporating one or more virtual machines (VMs);
a system implemented at least partially in a data center; or
a system implemented at least partially using cloud computing resources.

19. One or more processors comprising:
processing circuitry to:
obtain input data representative of one or more first frames, audio data, a first emotional state associated with a first portion of the one or more first frames, and a second emotional state associated with a second portion of the one or more first frames;
generate, using a diffusion model and based on the input data, denoised frames associated with the one or more first frames, a first portion of the denoised frames depicting an animation of the character as vocalizing a first portion of the audio data and expressing the first emotional state and a second portion of the denoised frames depicting an animation of the character as vocalizing a second portion of the audio and expressing the second emotional state; and
perform one or more operations using the one or more denoised frames.

20. The one or more processors of claim 19, wherein the one or more processors are comprised in at least one of:
a control system for an autonomous or semi-autonomous machine;
a perception system for an autonomous or semi-autonomous machine;
a system for performing one or more simulation operations;
a system for performing one or more digital twin operations;
a system for performing light transport simulation;
a system for performing collaborative content creation for 3D assets;
a system that provides one or more cloud gaming applications;
a system for performing one or more deep learning operations;
a system implemented using an edge device;
a system implemented using a robot;
a system for performing one or more generative AI operations;
a system for performing operations using one or more large language models (LLMs);
a system for performing operations using one or more vision language models (VLMs);
a system for performing operations using one or more multi-modal language models;
a system for performing one or more conversational AI operations;
a system for generating synthetic data;
a system for presenting at least one of virtual reality content, augmented reality content, or mixed reality content;
systems implementing one or more multi-modal language models;
systems using or deploying one or more inference microservices;
systems that incorporate deploy one or more machine learning models in a service or microservice along with an OS-level virtualization package (e.g., a container);
a system incorporating one or more virtual machines (VMs);
a system implemented at least partially in a data center; or
a system implemented at least partially using cloud computing resources.
